(19) United States
(12) Patent Application Publication
(10) Pub. No.: US 2007/0088680 A1
(43) Pub. Date: Apr. 19, 2007

(54) Simultaneously spawning multiple searches across multiple providers

(75) Inventors: Aaron J. Sauve, Seattle, WA (US); Cornelis K. Van Dok, Bellevue, WA (US); Carlos Yeung, Bellevue, WA (US); Prashant Singh, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/251,397

(22) Filed: Oct. 14, 2005

(51) Int. Cl. G06F 17/30

(52) U.S. Cl. 707/3

(57) ABSTRACT

Various embodiments provide the ability to simultaneously spawn a search across multiple different data providers. In at least some embodiments, the simultaneous spawning of the searches takes place in the context of a tabbed browsing environment. There, individual tabs of a browser are each associated with a different data provider and the user has the ability to simultaneously spawn their search across multiple data providers and access their search results using the tabs. Hence, the user can access search results across multiple different providers within the same browser window.

### BACKGROUND

Typically in the context of networks having searchable data providers, users have to individually enter search parameters and separately search each data provider. As an example, consider the Internet context. There, if a user wishes to search for topics using multiple different data providers, they must separately enter each search for each individual data provider. Needless to say, this can be a time consuming and inefficient approach.

### SUMMARY

Various embodiments provide the ability to simultaneously spawn a search across multiple different data providers. In at least some embodiments, the simultaneous spawning of the searches takes place in the context of a tabbed browsing environment. There, individual tabs of a browser are each associated with a different data provider and the user has the ability to simultaneously spawn their search across multiple data providers and access their search results using the tabs. Hence, the user can access search results across multiple different providers within the same browser window.

### BRIEF DESCRIPTION OF THE DRAWINGS

FIG. 1 illustrates a system in which the inventive principles can be employed.

FIG. 2 is a flow diagram that describes steps in a method in accordance with one embodiment.

FIG. 3 illustrates a browser window in a tabbed browsing environment in which the inventive principles can be employed.

FIG. 4 illustrates a search box in accordance with one embodiment.

FIG. 5 illustrates a browser window having a search box and tabs in accordance with one embodiment.

FIG. 6 is a flow diagram that describes steps in a method in accordance with one embodiment.

### DETAILED DESCRIPTION

Overview

Various embodiments provide the ability to simultaneously spawn a search across multiple different data providers. In at least some embodiments, the simultaneous spawning of the searches takes place in the context of a tabbed browsing environment. There, individual tabs of a browser are each associated with a different data provider and the user has the ability to simultaneously spawn their search across multiple data providers and access their search results using the tabs. Hence, the user can access search results across multiple different providers within the same browser window.

The discussion below contains the following sections. First, a section entitled “Simultaneously Spawning Searches Over Multiple Providers” describes the notion of searching simultaneously over multiple different data providers. Next, a section entitled “Tabbed Browsing” is provided and introduces those readers who are unfamiliar with tabbed browsing to the concept. This section provides some background for a discussion that follows in the section entitled “Simultaneously Searching Across Multiple Tabs”, which provides but one example of an environment in which the inventive principles can be employed. Following this section, a section entitled “In Operation” appears and describes aspects of one particular implementation.

Simultaneously Spawning Searches Over Multiple Providers

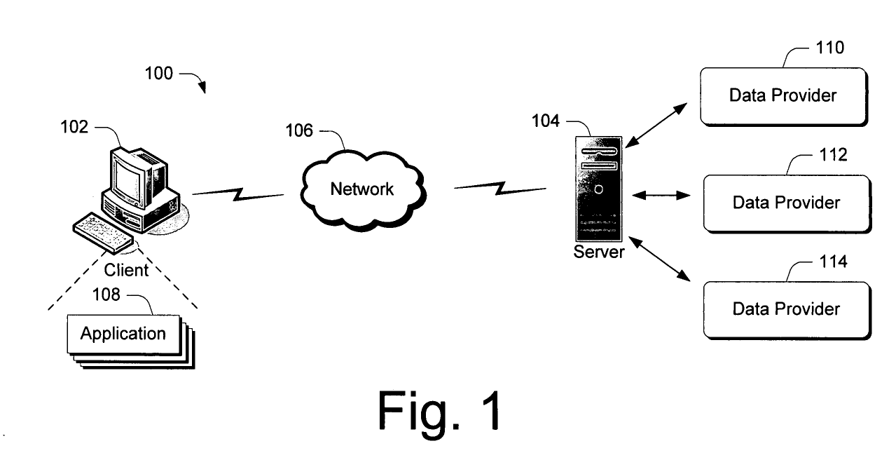

FIG. 1 illustrates an exemplary system, generally at 100, in which a user can simultaneously spawn searches over multiple providers in accordance with one embodiment. There, system 100 includes a client 102 in the form of a computing device, a server 104 and a network 106 through which client 102 and server 104 can communicate. Client 102 can comprise any suitable computing device, such as a general purpose computer, handheld computer and the like. Network 106 can comprise any suitable network. In one embodiment, network 106 comprises the Internet.

In this example, client 106 embodies one or more software applications 108 through which a user can initiate a search. Applications 108 typically reside in the form of computer-readable instructions that reside on some type of computer-readable medium. Although any suitable application can be used, in the embodiments described in this document, an application in the form of a web browser is used. It is to be appreciated and understood, however, that other types of applications can be used without departing from the spirit and scope of the claimed subject matter.

In this embodiment, server 104 has access to multiple different data providers 110, 112 and 114. The data providers can comprise any suitable type of data provider. For example, in some embodiments, a data provider can provide certain types of specialized data, such as news data, sports data and the like. In yet other embodiments, and one which is used as an example throughout this document, the data provider comprises a search provider. A search provider in this context is an entity that provides or exposes search functionality that enables a user to search the web for content. Examples of search providers include MSN, Google, Yahoo and the like.

In this example, application 108 displays visual indicia that allow the user to conduct or spawn a search across multiple different data providers. Any suitable visual indicia can be used, specific examples of which are given below.

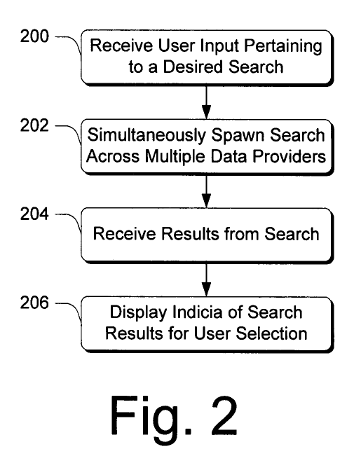

FIG. 2 is a flow diagram that describes steps in a method in accordance with one embodiment. The method can be implemented in connection with any suitable hardware, software, firmware or combination thereof. In one embodiment, the method is implemented in software in the form of an application that executes on a client computing device.

Step 200 receives user input pertaining to a desired search that the user wishes to conduct. The user input can comprise any suitable input. For example, such input can include a user selecting appropriate elements in a user interface to indicate that a search is desired. Such input can also include selecting a number of different data providers. Alternately or additionally, the multiple different data providers might be selected by a default setting. In addition, this step can be implemented by a user entering, in an appropriate user interface element, the terms, words or concepts that are the subject of the search. For example, in the context in which the data providers are search providers, this step can be implemented by a user entering the search terms that they desire to search.

Step 202 simultaneously spawns a search across multiple different data providers. This step can be implemented in any suitable way. For example, each search can be individually configured for its particular associated data provider and sent to the data provider for execution. That is, typically data providers have a particular format in which they receive search requests. In this case, an individual search can be specifically formatted into multiple different formats that are appropriate for particular data providers. Once configured, the search requests can be sent to the appropriate entity for execution. In this example, the simultaneous spawning of the search refers to setting up and implementing the search responsive to a set of user actions that would be sufficient to set up and implement a search across a single data provider. One example of such a set of user actions would be simply entering the search terms and clicking the “Enter” button.

Step 204 receives the results from the multiply-spawned search and step 206 displays indicia of the search results for user selection. Any suitable visual indicia can be utilized to visually represent to the user the results of their search. One specific example is provided below. Having the indicia displayed for the user, the user can now navigate through their search results.

Hence, in this example, a set or subset of actions that are typically associated with a single search across a single data provider is utilized to spawn a search across multiple different data providers. This approach more efficiently uses a user's time and resources, as will be appreciated by the skilled artisan.

Tabbed Browsing

As noted above, in at least some embodiments, the inventive principles are implemented in the context of a tabbed browsing environment. Tabbed browsing refers to the ability to organize and manage groups of web pages using so-called “tabs” that are displayed as part of the browser's user interface. Using tabbed browsing, web pages are loaded in tabs within the same browser window, thus making it easier to switch back and forth among multiple web pages. This enables a user, for example, to load all of their favorite web sites with one click. For example, a user might bookmark all of their favorite web sites and place them in a folder. By selecting an option that allows them to open the folder in tabs, all of their favorite web sites will be loaded at once.

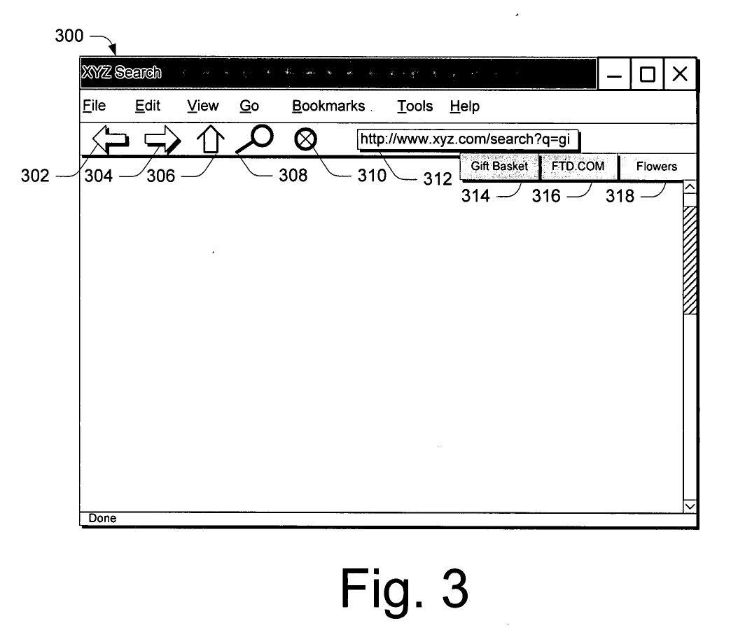

As an example, consider FIG. 3 which illustrates an exemplary browser window 300. There, window 300 includes a number of typical user interface elements such as back and forward navigation elements 302, 304 respectively, a home element 306, a search element 308 and a stop element 310. In addition, an address bar 312 is provided in which a user can type an associated web address to have the browser window navigated to that address.

In addition, just below the address bar appear three tabs 314, 316 and 318. Each of these individual tabs is associated with an individual web page. Accordingly, by clicking on a particular tab, focus of the browser window is shifted to that web page which, in turn, changes some of the state information associated with the browser window. For example, when the user clicks on tab 314, the web page associated with that tab is brought into focus and the navigation instrumentalities (e.g. back and forward elements 302, 304) are now associated with navigation activities that occur relative to that web page. The same thing occurs when the user clicks on tabs 316 and 318.

Accordingly, tabs provide the ability to display visible indicia to a user that represents the web page with which the tab is associated, as well as the ability for the user to select and quickly navigate the web pages.

Simultaneously Searching Across Multiple Tabs

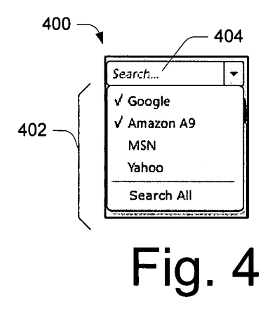

In at least some embodiments, a user can spawn a search across multiple providers over a set of tabs. A user first selects the providers across which to search. This can be done in any number of ways. For example, a search can default to all of the installed providers. As an example, consider FIG. 4 which shows an exemplary user interface element 400 in the form of a search box. The search box can be presented as part of the browser window that the user sees when they open a browser. In this example, search box 400 includes an area 402 that displays the individual installed providers, and an area 404 in which the user can type in their search terms.

The user might select the default group of search providers by dropping down the menu to expose the installed providers-here, Google, Amazon A9, MSN and Yahoo. Then, the user might hotkey select all of the providers by simply pressing CTRL+Enter when focus is in the search box. Alternately or additionally, the user might individually select search providers by, for example, selecting the providers when the focus is in the search box dropdown menu. In this case, a check might appear next to the individual selected providers.

Once the user enters their particular search in area 404, the search is simultaneously spawned across the multiple different providers and a new tab is opened for each individual provider and the search results for each provider are presented within the tab. Using the individual tabs, a user can then quickly navigate and switch between the tabs to view all of the results.

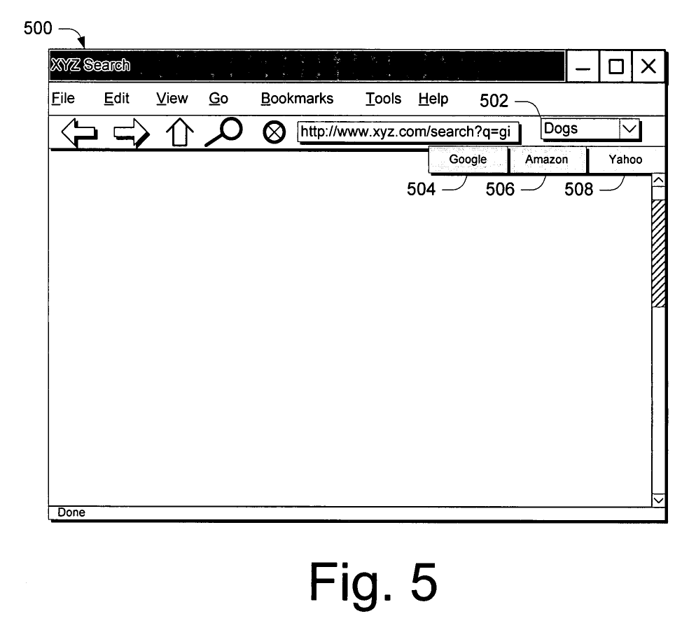

As an example, consider FIG. 5 which illustrates an exemplary browser window 500. Here, browser window includes a search box 502 and individual tabs 504, 506 and 508. In this particular example, the user has used the search box and selected providers Google, Amazon and Yahoo and entered a search on the term “Dog”. Accordingly, this search is spawned across Google, Amazon and Yahoo and the results of each of the individual searches are associated with their own tab in the browser window. Accordingly, the user can quickly navigate the tab and view their search results.

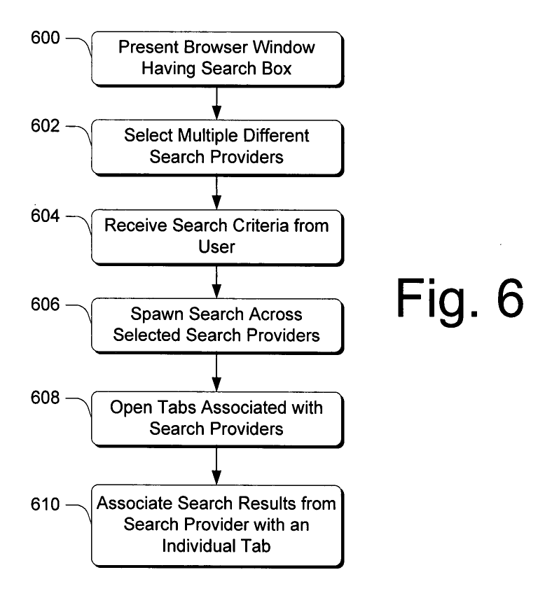

FIG. 6 is a flow diagram that describes steps in a method in accordance with one embodiment. The method can be implemented in connection with any suitable hardware, software, firmware or combination thereof. In one embodiment, the method is implemented in software in the form of an application that executes on a client computing device.

Step 600 presents a browser window having a search box. Any suitable browser window and search box can be utilized. One example of such a window and search box is given above in FIG. 5. Step 602 selects multiple different search providers. Any suitable way can be utilized to select providers. For example, a user might select a default collection of search providers. Alternately or additionally, the user might individually select providers. Step 604 receives search criteria from the user. This step can be performed in any suitable way. In but one embodiment, the user's search criteria can be received via a search box, such as the one shown and described above.

Step 606 spawns an associated search across the selected search providers. This step can be performed in any suitable way, an example of which is provided below. Step 608 open tabs associated with the individual search providers. In this example, each search provider has its own associated tab. Step 610 then associates the search results from individual search providers with an individual tab. One example of how this can be done is given above in FIG. 5. By associating the search results with individual tabs, a user can quickly navigate between their search results within a single browser window.

In Operation

The above methodology can be implemented in any suitable way using any suitable technology. The discussion that follows provides but one example of how this methodology can be implemented.

In one implementation, the multiple different searches are spawned using a multi-threaded approach. In this case, each individual tab is associated with its own thread. When a user enters a search term after having selected the search providers, code executing as part of the browser prepares a GET request for each individual search. Preparing a GET request involves looking in the registry and preparing the appropriate URL for an individual search provider. For each selected search provider, a separate GET request is prepared and sent to the appropriate server. The server then processes the GET request and returns a result set. Each result set for an individual search provider is associated with its own tab and presented to the user in a manner that permits quick referencing.

Other approaches can, however, be utilized without departing from the spirit and scope of the claimed subject matter.

Conclusion

Various embodiments described above provide the ability to simultaneously spawn a search across multiple different data providers. In at least some embodiments, the simultaneous spawning of the searches takes place in the context of a tabbed browsing environment. There, individual tabs of a browser are each associated with a different data provider and the user has the ability to simultaneously spawn their search across multiple data providers and access their search results using the tabs. Hence, the user can access search results across multiple different providers within the same browser window.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
receiving user input pertaining to a desired search that the user wishes to conduct; and
simultaneously spawning an associated search across multiple different data providers.

2. The method of claim 1, wherein the data providers comprise search providers.

3. The method of claim 1, wherein the data providers comprise search providers and the search is spawned over the Internet.

4. The method of claim 1 further comprising:
receiving results from the search across the multiple different data providers; and
displaying indicia of the search results for the user.

5. The method of claim 4, wherein the act of displaying comprises displaying the indicia within a single browser window.

6. The method of claim 5, wherein said indicia comprise individual tabs.

7. The method of claim 4, wherein said acts of receiving user input, spawning an associated search, receiving results and displaying indicia are performed by a web browser application.

8. A computer-implemented method comprising:
selecting, responsive to user input, multiple different search providers;
spawning, responsive to user input, a search across the multiple different search providers; and
presenting search results associated with the search in individual tabs within a single window.

9. The method of claim 8, wherein the single window is a single browser window.

10. The method of claim 8, wherein said acts of selecting and spawning are performed responsive to user input that is received via a web browser.

11. The method of claim 10, wherein said user input is received through a search box.

12. A computer-implemented method comprising:
presenting a browser window having a search box that can be utilized to enter search terms;
selecting, responsive to user input, multiple different data providers;
receiving, via the search box, search criteria from the user;
spawning an associated search across the selected data providers;
opening one or more tabs associated with the search; and
associating search results from the data providers with the one or more tabs.

13. The method of claim 12, wherein the data providers comprise search providers.

14. The method of claim 12, wherein the data providers comprise search providers, and the search is spawned over the Internet.

15. The method of claim 12, wherein the act of opening comprises opening a tab for each individual data provider that is selected.

16. The method of claim 12, wherein the act of spawning comprises doing so using a multi-threaded approach.

17. The method of claim 12, wherein the act of selecting is performed by enabling the user to select data providers using the search box.

18. The method of claim 12 further comprising displaying said one or more tabs for user selection within said browser window.

19. The method of claim 12, wherein the data providers comprise search providers and said opening comprises opening a tab for each individual search provider that is selected.

20. The method of claim 12, wherein the data providers comprise search providers and said opening comprises opening a tab for each individual search provider that is selected and further comprising displaying said one or more tabs for user selection within said browser window.
